(19) United States
(12) Patent Application Publication
(10) Pub. No.: US 2006/0040076 A1
(43) Pub. Date: Feb. 23, 2006

(54) Formable film for cold-form, blister-type pharmaceutical packaging

(76) Inventors: Stephen K. Franzyshen, Richmond, VA (US); Christine A. Creegan, Richmond, VA (US)

Correspondence Address: RATNERPRESTIA, P.O. BOX 1596, WILMINGTON, DE, 19899, US

(21) Appl. No.: 10/920,532

(22) Filed: Aug. 18, 2004

(51) Int. Cl. B32B 27/08

(52) U.S. Cl. 428/35.7

(57) ABSTRACT

Cold-formable film composite structures useful for pharmaceutical blister packaging may be constructed from a first polyester surface layer that has a low extractables level, an aluminum layer adhered to the first surface layer, and an additional layer adhered to the aluminum layer. A second surface layer may be adhered to the additional layer. Blister packs may be prepared from such composite structures by cold-forming the structures such that the first polyester surface layer is inside the blister, facing the pharmaceutical. The use of a low-extractables material on the inside surface of the blister minimizes the potential for contamination of the pharmaceutical within the package.

### FIELD OF THE INVENTION

The invention relates to cold-formable film composite structures. More particularly, it relates to such structures suitable for use in forming pharmaceutical packaging, such as blister packs.

### BACKGROUND OF THE INVENTION

Pharmaceutical compositions, especially those packaged as individual pre-measured doses, present significant packaging challenges. Many such compositions are sensitive to environmental conditions, including light and moisture. Given the frequently considerable cost of such compositions, as well as the importance of delivering the intended dose of active drug, losses or deterioration due to such environmental factors often must be rigorously protected against.

Blister packs have been used for many years to provide individually dosed pharmaceutical compositions. Currently, there is an increasing demand for higher-performance blister packs that have improved properties. For example, there is an increasing interest in providing blister-packed dry powder inhalant (DPI) pharmaceutical compositions for individual use. However, one of the challenges associated with such uses is that, since such compositions are designed to be inhaled into the lungs, which are highly sensitive to foreign matter, it is essential that contamination of the drug with any potentially harmful material be kept to an absolute minimum. In particular, there is a concern that extractable material in the surface of the blister pack that contacts the drug may be carried into it, creating a potential hazard. Thus, there is a need for blister packs made from materials that provide an acceptable level of resistance to light, moisture, etc., and that have a very low level of extractable content.

### SUMMARY OF THE INVENTION

In one aspect, the invention provides a film composite structure that includes a first surface layer that includes a biaxially oriented polyester film layer having an extractables level less than 15,000 ppm by weight. The composite structure further includes:

(a) a first adhesive layer on the first surface layer;

(b) an aluminum layer on the adhesive layer; and

(c) an additional layer over the aluminum layer.

The film composite structure is a cold-formable structure suitable for non-contaminating contact with a pharmaceutical product.

In another aspect, the invention provides a pharmaceutical product container including a film composite structure as defined immediately above. The film composite structure includes a blister, surrounded by a flange, having a concave inner surface defining a cavity adapted to receive the pharmaceutical product, the first surface layer of the structure forming the concave inner surface.

In yet another aspect, the invention provides a method of forming a pharmaceutical product container as described immediately above. The method includes:

(a) providing a complementary pair of die elements;

(b) positioning the composite structure between the elements; and

(c) pressing the die pair elements in complementary engagement without applying external heating to the composite structure to cold-form the composite structure, thereby forming the cavity.

### BRIEF DESCRIPTION OF THE DRAWINGS

FIG. 1 is a sectional view of a cold-formable composite structure according to the invention.

FIG. 2 is a sectional view of another cold-formable composite structure according to the invention.

FIG. 3 is a sectional view of a blister pack made from a cold-formable composite structure according to the invention.

### DETAILED DESCRIPTION OF THE INVENTION

The invention will next be illustrated with reference to the Figures, wherein the same numbers indicate the same elements in all Figures. Such Figures are intended to be illustrative rather than limiting and are included herewith to facilitate the explanation of the present invention. The Figures are not to scale, and are not intended to serve as engineering drawings.

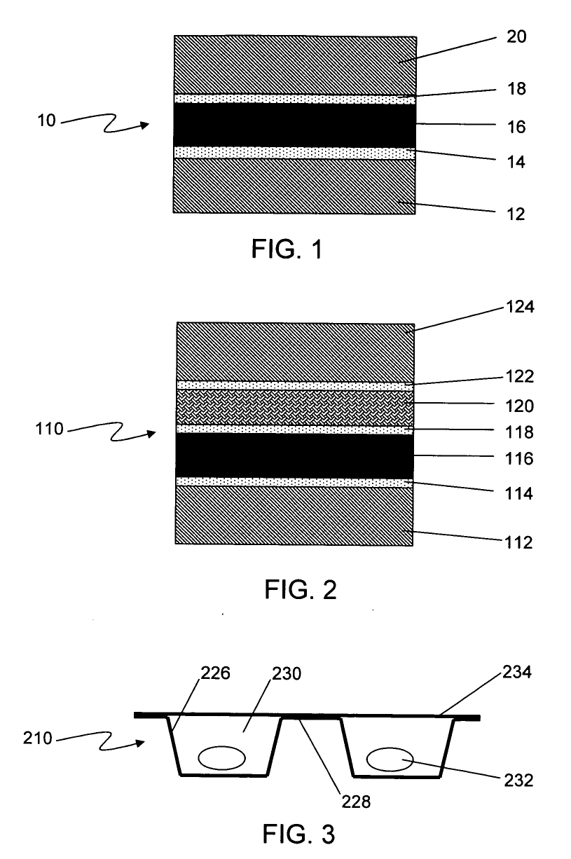

Referring now to FIG. 1, the invention provides a cold-formable film composite structure, indicated generally at 10. The structure includes a first surface layer 12 that has a low extractables level, adhered via a first adhesive layer 14 to an aluminum layer 16. An optional second adhesive layer 18 adheres an additional layer 20 to the aluminum layer 16.

Referring to FIG. 2, there is shown another cold-formable film composite structure, indicated generally at 110, according to the invention. The structure includes a first surface layer 112 that has a low extractables level, adhered via a first adhesive layer 114 to an aluminum layer 116. An optional second adhesive layer 118 adheres an additional layer 120 to the aluminum layer 116. On additional layer 120 is an optional third adhesive layer 122, which adheres a second surface layer 124 that has a low extractables level in a position opposite the first surface layer 112. Such a structure may provide a higher level of tear- and dent-resistance to packaging made from it, particularly if the additional layer 120 is an oriented polyamide, such as nylon. A detailed description of the exemplary embodiments shown in FIGS. 1 and 2 will now be provided.

First Surface layer

First surface layer 12, 112 is a polyester film, with one preferred example being a polyethylene terephthalate (PET) film. It may be of any thickness, but typically will have a thickness between 12 and 100 μm, more typically between 36 and 60 μm.

Polyethylene terephthalate polymer preparation techniques are well known to those skilled in the art and are disclosed in many texts, such as Encyclopedia of Polymer Science and Engineering, 2nd. Ed., Vol. 12, Wiley, N.Y., pp. 1-313. The polymer is typically obtained by condensing the appropriate dicarboxylic acid or its lower alkyl diester with ethylene glycol. Polyethylene terephthalate is formed from terephthalic acid or an ester thereof, and polyethylene naphthalate is formed from 2,7-naphthalene dicarboxylic acid or an ester thereof.

Exemplary polyesters for use according to the invention include copolyesters of PET, where the copolyester component can be its acid component or alcohol component, or both. Examples of the acid component include aromatic dibasic acids such as isophthalic acid, phthalic acid and naphthalenedicarboxylic acid; aliphatic dicarboxylic acids such as adipic acid, azelaic acid, sebacic acid and decanedicarboxylic acid; alicyclic dicarboxylic acids such as cyclohexanedicarboxylic acid; etc. Examples of the alcohol component include aliphatic diols such as butanediol and hexanediol and alicyclic diols such as cyclohexanedimethanol, etc. These can be used alone or in a combination of two or more.

Exemplary copolyesters suitable for use in forming first surface layer 12, 112 include terephthalic acid in an amount of 82 to 100 mol % and 2,6-naphthalenedicarboxylic acid, or a combination of 2,6-naphthalenedicarboxylic acid and one or more other dicarboxylic acids to constitute 0 to 18 mol % of the total of all dicarboxylic acid components.

Illustrative examples of the other dicarboxylic acid include aromatic dicarboxylic acids such as isophthalic acid and phthalic acid; aliphatic dicarboxylic acids such as adipic acid, azelaic acid, sebacic acid and decanedicarboxylic acid; and alicyclic dicarboxylic acids such as cyclohexanedicarboxylic acid. They may be used alone or in combination of two or more.

Other exemplary copolyesters suitable for use in forming first surface layer 12, 112 include ethylene glycol in an amount of 82 to 100 mol % and cyclohexanedimethanol or a combination of cyclohexanedimethanol and another diol in an amount of 0 to 18 mol % of the total of all diol components.

Illustrative examples of the other diols include aliphatic diols such as diethylene glycol, propylene glycol, neopentyl glycol, butanediol, pentanediol and hexanediol; alicyclic diols such as cyclohexanedimethanol; aromatic diols such as bisphenol A; and polyalkylene glycols such as polyethylene glycol and polypropylene glycol. They may be used alone or in combination of two or more.

In some embodiments of the invention, the polyester used in the first surface layer has a glass transition temperature between 50 and 65° C., typically between 58 and 61° C., and a melting point between 228 and 240° C., typically between 232 and 238° C. Polyesters exhibiting these glass transition temperatures and/or melting points may be made by incorporating comonomer repeating units into the polyester.

In certain preferred embodiments of the invention, the polyester film layer includes polyethylene terephthalate having between 2.0 and 8.0 wt % of linear aliphatic a,ω-dicarboxylic acid repeating units selected from the group consisting of suberic acid, azelaic acid, and sebacic acid repeating units. Typically, the level of a,ω-dicarboxylic acid repeating units will be between 3.0 and 6.0 wt %, more typically between 4.0 and 5.0 wt %. Azelaic acid repeating units are preferred. In certain preferred embodiments, the polyester is essentially free of aromatic acid repeating units other than terephthalic acid. By “essentially free,” it is meant that no other aromatic acid repeating units are purposely included in the polyester. It has been found that the inclusion of certain amounts of a,ω-dicarboxylic acid repeating units as outlined above greatly enhances the cold-forming performance of film composite structures. It is believed that such performance enhancement is not readily obtainable by the use of other aliphatic diacids, or of aromatic diacids, to form repeating units in the polyester.

The polyester may additionally, or instead, include between 1.0 and 4.0 wt % of diethylene glycol repeating units, typically between 1.2 and 2.8 wt %, more typically between 1.5 and 2.5 wt %. It has been found that a combination of a,ω-dicarboxylic acid and diethylene glycol repeating units is particularly effective in providing the first surface layer 12, 112 according to the invention.

Polyester useful for making first surface layer 12, 112 may have an intrinsic viscosity within a wide range. Typically, the intrinsic viscosity of the polyester will be from about 0.52 to about 0.80, preferably 0.58 to 0.70, even more preferably 0.62 to 0.65. If the intrinsic viscosity is too low, even if other physical properties are appropriate and cold-forming is performed satisfactorily, the film may become brittle and fracture or delaminate. There does not appear to be a performance disadvantage to using polymers with intrinsic viscosity above about 0.80, but such polymers tend to be more expensive and more difficult to process in cold-forming equipment. For purposes of this invention, the intrinsic viscosity of a polyester is measured at 25° C. using o-chlorophenol as a solvent.

Typically, but not necessarily, the film used to form first surface layer 12, 112 is biaxially oriented, if it comprises a polyester. Biaxial orientation of the polyester film may be accomplished by stretching the composite in sequence in two mutually perpendicular directions, typically at a temperature in the range of about 70 to 110° C. Typically, draw ratios will be about 2.8 and 3.4 in the machine and transverse directions, respectively. Such ratios, which are lower than those typically used for polyesters, tend to improve the cold-formability of the film. The stretching operation is preferably followed by heat setting under dimensional restraint, typically at a temperature in the range 170 to 200° C. Suitable processes for stretching and heat setting are described in U.S. Pat. No. 3,107,139.

The first surface layer 12, 112 may also include a slip additive, which typically improves the ability of the composite structure to be cold-formed to the desired shape without forming delaminations, fractures, pinholes, or other defects. Any slip additive may be used, such as talc, clays, etc, but typically the additive will be a silica. The total loading of slip additive will depend upon the exact type of additive, the exact composition of the first surface layer 12, 112, and perhaps other factors. Typically, the amount will be between 100 and 1000 ppm by weight relative to the polymer making up the layer, more typically between 200 and 600 ppm. In one exemplary embodiment of the invention, a combination of 200 ppm each of Sylysia® 310P and Sylysia® 340 is used. Both of these are available from Fuji Silysia Chemical Ltd. of Research Triangle Park, N.C. One suitable material for making first surface layer 12, 112 is Mylar® P25 polyester film, available from DuPont Teijin Films of Wilmington, Del.

First surface layer 12, 112 has a low level of extractables. As used herein, the term “low level of extractables” means a material having an extractables level below 15,000 ppm by weight as determined by the method outlined in the Example below. Typically, the level is below 12,000 ppm. In particular, it contains no added dioctyl tin ethylhexyl thioglycolate or antioxidants. Thus it contains no added triethylene glycol bis-3-(3-tert-butyl-4-hydroxy-5-methylphenyl) propionate, a commonly used antioxidant in some polymer films. The polyester in first surface layer 12, 112 is free of plasticizers, i.e. it contains no added plasticizers, since such materials might be extractable. Because first surface layer 12, 112 has a low extractables level, it is suitable for non-contaminating contact with a pharmaceutical product. Thus, for example, it may constitute the inner surface of a blister pack, such as may be used for products where a high level of purity is desired.

Adhesive Layers

First adhesive layer 14, 114 is capable of forming an adhesive bond to first surface layer 12, 112 and to aluminum layer 16, 116. The adhesive layer may be of any thickness, but typically will have a thickness between 0.1 and 12 μm, more typically between 2 and 8 μm. Any of a number of adhesives known in the film composite art may be used, employing known application techniques, to form first adhesive layer 14, 114. Suitable exemplary adhesive compositions may contain solvents, be solvent-free, or may be aqueous acrylic adhesives or polyurethane adhesive systems. Adhesives which harden under the influence of electromagnetic rays (e.g. UV; electron beams) may, however, also be employed. In some embodiments, a polyurethane-based laminating adhesive, such as a di-isocyanate or aliphatic polyester, may be used. Second adhesive layer 18, 118 and third adhesive layer 122, if present, may be made and applied in any of the same ways as first adhesive layers 14, 114. Either or both of the second and third adhesive layers may be the same as, or different from, the material used in the first adhesive layer, and may or may not be of the same thickness.

In one exemplary embodiment, first adhesive layer 14, 114 may be a thermal bonding adhesive. It may be formed on a surface of the first surface layer 12, 112, or on a surface of the aluminum layer 16, 116. Adhesion may be achieved by first heating one or both of the surfaces to be bonded to a temperature high enough to soften layer 14, 114 but not high enough to soften or melt the first surface layer 12, 112, and then by applying pressure, typically by nipping the film to the metal with a rubber roll.

If first adhesive layer 14, 114 is a thermal bonding adhesive, it may comprise any of a number of materials meeting the above-mentioned requirements, and many such materials are known in the art, for example ethylene-vinyl acetate copolymers. In one exemplary embodiment of the invention, first adhesive layer 14, 114 may comprise a solvent based copolyester adhesive coating based on Vitel® 1200B resin, available from Bostik Findley, Inc., Middleton, Mass., and/or Crystar® 3991 resin, available from DuPont of Wilmington, Del. A typical solvent for applying such adhesives is a blend of tetrahydrofuran and toluene.

In some exemplary embodiments of the invention, first adhesive layer 14, 114 may comprise a thermal bonding polyester resin, particularly a copolyester resin derived from one or more dibasic aromatic carboxylic acids, such as terephthalic acid, isophthalic acid and hexahydroterephthalic acid, and one or more glycols, such as ethylene glycol, diethylene glycol, triethylene glycol and neopentyl glycol. First adhesive layer 14, 114 may comprise a terephthalate-containing polyester. A preferred copolyester is derived from terephthalic acid and one or both of isophthalic acid and hexahydroterephthalic acid, and one or more glycols, preferably ethylene glycol. Exemplary copolyesters that provide satisfactory bonding properties in the amorphous state are those of ethylene terephthalate and ethylene isophthalate, especially in the molar ratios 60 to 90 mol % ethylene terephthalate and correspondingly 40 to 10 mol % ethylene isophthalate. Particularly preferred copolyesters comprise 70 to 85 mol % ethylene terephthalate and 30 to 15 mol % ethylene isophthalate, for example a copolyester of approximately 80 mol % ethylene terephthalate and approximately 20 mol % ethylene isophthalate. Use of a thermal bonding polyester resin for first adhesive layer 14, 114 may reduce the potential for contact of a packaged pharmaceutical product with extractables that might otherwise be present in the adhesive. For example, surfactants and other low molecular weight species, which might be extractable, may in some cases be present in water-based coating adhesives, and may diffuse through the first surface layer 12, 112 to contaminate the pharmaceutical product.

In manufacturing cold-formable film composite structures according to the invention, it may be advantageous to provide first surface layer 12, 112 and first adhesive layer 14, 114 together in the form of an adhesive-bearing film composite. This may be formed by solvent casting or extrusion of the adhesive layer onto the surface of colored layer 16 of first surface layer 12, 112, in the case where the composite comprises a biaxially oriented and heat-set film of polyethylene terephthalate or polyethylene naphthalate.

In the case where first surface layer 12, 112 comprises biaxially oriented polyethylene terephthalate, and the first adhesive layer 14, 114 is a copolyester resin as described above, the adhesive-bearing film composite may be conveniently made by a process that includes multiple extrusion through a multiple orifice die or coextrusion of the composite layers, e.g. broadly as described in U.S. Pat. No. 3,871,947, followed by molecular orientation by stretching in one or more directions and heat setting. A convenient process and apparatus for coextrusion, known as single channel coextrusion, is described in U.S. Pat. No. 4,165,210 and GB patent specification No. 1,115,007. The method comprises simultaneously extruding streams of the first and second of two polyesters from two different extruders, uniting the two streams in a tube leading to a manifold of an extrusion die, and extruding the two polyesters together through the die under conditions of streamline flow so that the two polyesters occupy distinct regions of the flow without intermixing, whereby a film composite is produced.

As noted above, biaxial orientation of the polyethylene terephthalate portions of the film composite may be accomplished by stretching the composite in sequence in two mutually perpendicular directions typically at temperatures in the range of about 70 to 110° C. Generally, the conditions applied for stretching the composite may function to partially crystallize the adhesive layer, and in such cases it is preferred to heat set the film composite under dimensional restraint at a temperature greater than the crystalline melting temperature of the adhesive layer, but lower than the crystalline melting temperature of the polyethylene terephthalate portions. The composite is then permitted or caused to cool, rendering the adhesive layer essentially amorphous while high crystallinity is maintained in the first surface layer. Therefore, the stretching operation is preferably followed by heat setting under dimensional restraint, typically at a temperature in the range 170 to 200° C.

Aluminum Layer

Aluminum layer 16, 116 is an aluminum foil layer. It may be of any thickness, but typically will have a thickness between 25 and 100 μm, more typically between 45 and 65 μm. Suitable aluminum foils are well known in the art, including foils that are especially suited for cold forming applications. One suitable example is 8079 alloy aluminum foil, available from Alcoa of Pittsburgh, Pa.

Additional Layer

Additional layer 20, 120 may be of any thickness, but typically will have a thickness between 15 and 100 μm, more typically between 20 and 50 μm. Typically, additional layer 20, 120 includes a polymer film. Any polymer may be used for the film. Nonlimiting examples of suitable polymers include halogen-containing polymers such as polyvinyl chloride (PVC), copolymers of vinyl chloride with vinyl esters of aliphatic acids, copolymers of vinyl chloride with esters of (meth)acrylic acid or esters thereof, or with acrylonitrile, copolymers of dienes with unsaturated dicarboxylic acids or their anhydrides, copolymers of vinyl chloride with unsaturated aldehydes or ketones, and polymers and copolymers of vinylidene chloride with vinyl chloride or other comonomers.

Additional layer 20, 120 may comprise a polyolefin film. Suitable polyolefins include polyethylenes (PE) such as high density polyethylene (HDPE, density larger than 0.944 g/cm³), medium density polyethylene (MDPE, density 0.926-0.940 g/cm³), linear medium density polyethylene (LMDPE, density 0.926.0.940 g/cm³), low density polyethylene (LDPE, density 0.910-0.925 g/cm³), and linear low density polyethylene (LLDPE, density 0.916-0.925 g/cm³), for example as unoriented, uniaxially, or biaxially oriented films. Also suitable are polypropylene (PP) films, such as uniaxially or biaxially oriented polypropylene (oPP film) or cast polypropylene (cPP film), amorphous or crystalline polypropylene or mixtures thereof, atactic or isotactic polypropylene or mixtures thereof, poly-1-butene, poly-3-methylbutene, poly-4-methylpentene and copolymers thereof, and copolymers of ethylene with vinyl acetate, vinyl alcohol, acrylic acid etc. such as for example ionomeric resins. Exemplary copolymers include those of ethylene with acrylic acid, methacrylic acid, acrylic esters, tetrafluoroethylene or polypropylene, also statistical copolymers, block polymers or olefin polymer-elastomer mixtures. Preferred are high density polyethylenes and polypropylenes, ethylene-acrylic acid copolymers (EAA), and ionomers such as are sold under the trade name Surlyn available from DuPont of Wilmington, Del. Other non-limiting examples of materials suitable for making second additional layer 120 include polychlorotrifluoroethylene (PCTFE) films such as Aclar®, available from Honeywell International, Inc. of Morristown, N.J., COC (cyclic olefin copolymers) such as Topas®, available from Ticona of Summit, N.J., and PETG, available from Eastman Chemical Company of Kingsport Tenn.

In certain preferred embodiments, additional layer 20, 120 may comprise a polyamide film, which may help in stretching and forming the film composite structure. Nonlimiting examples of suitable polyamides include polyamide 6; polyamide 11; polyamide 12; polyamide 6,6; polyamide 6,10; polyamide 6,12; polyamide 6-3-T; and mixtures of these. The preparation of such polyamides, and films made from them, is well known in the art, and many bulk polymers and films are commercially available.

Films made from any of these materials may contain a softener or plasticizer, as is known in the art, and may be uniaxially or biaxially oriented, although this is not required.

In other embodiments of the invention, the additional layer is a PET copolyester such as described for the first surface layer 12, 112, and in some embodiments it is substantially identical to the first surface layer. Such a construction may, due at least in part to its symmetry, provide better lay-flat performance when the film is cold-formed.

Second Surface layer

The presence of a second surface layer 124 may provide additional crush resistance and stiffness to blister packages made from the film composite. It may be any polymer film, but preferably it will be made of a material that has a low extractables level. When the cold-form laminate is wound up in a roll, second surface layer 124 is in contact with first surface layer 112. If second surface layer 124 does not have a low level of extractables, it may potentially transfer unwanted extractables to first surface layer 112. Typically, second surface layer 124 will be a PET copolyester film such as described above in relation to the first surface layer 12, 112. Other non-limiting examples of materials suitable for making second surface layer 124 include polychlorotrifluoroethylene (PCTFE) films such as Aclar®, COC (cyclic olefin copolymers) such as Topas®, and PETG. Also suitable are films made from oriented or unoriented polypropylene or polyethylene naphthalate.

In some embodiments of the invention, the first and second surface layers will be PET copolyesters of the same composition. The second surface layer 124 may be of any thickness, but typically it will have a thickness between 12 and 100 μm, more typically between 25 and 60 μm. It may be, but need not be, of the same thickness as first surface layer 12, 112.

Pharmaceutical Product Container

FIG. 3 shows another cold-formable film composite structure, indicated generally at 210, according to the invention. The film composite structure 210, which may for example be suitable for use as a pharmaceutical product container, is made by cold-forming a composite structure such as shown in FIGS. 1 and 2. In FIG. 3, the composite structure has been formed to provide a blister having a concave inner surface 226 partially defining a cavity 230, which is adapted to receive a pharmaceutical product 232. The blister is surrounded by a flange 228. The first surface layer of the structure, as defined relative to FIGS. 1 and 2 (not shown here, for simplicity), forms the concave inner surface 226. Two blisters are shown in FIG.3, but there may be only one, or many. Typically the structure will include a plurality of blisters in a linear, rectangular, or other arrangement. In the embodiment shown in FIG. 3, an optional complementary lidding structure 234 is shown sealed to the flange 228. The lidding structure may be any such structure known in the packaging art, and typically includes an aluminum layer. In a preferred embodiment, the lidding structure 234 is constructed as described above in relation to FIG. 1, with the first surface layer 12 (not shown, for simplicity) facing inward toward pharmaceutical product 232. Typically, the lidding structure is adhered to the blister with a thermally activated heat seal adhesive, such as a solvent-based polyester resin, that also has a low level of extractables. In this way, the entire packaging surface to which the pharmaceutical product is exposed consists of materials that have a low level of extractables.

The structure 210 is prepared by a cold-forming process. The term “cold-forming,” as used herein, means pressure-forming below the glass transition temperature of any of the film layers in the structure. Typically it is performed with a composite structure having a temperature of at most 40° C., more typically at most 35° C., at the time it enters the cold-forming die. Suitable methods and equipment for such cold-forming are well known in the art, and any of these may be used according to the invention. Exemplary equipment is sold commercially by Uhlmann Packaging Systems LP of Towaco, N.J. In general, cold-forming involves pressing a composite film structure of this invention between a complementary pair of Teflon® die elements. The composite structure may optionally be heating, prior to the pressing, to a temperature below the glass transition temperature of the first surface layer of the composite structure.

### EXAMPLE

Samples of two polymer film materials were analyzed for extractables content, according to the following method. The first film, suitable for use as the first surface layer 12, 112, was a Mylar® P25 polyester film, and the second was a commercially available 60-μm polyvinyl chloride (PVC) film.

An approximately 0.5-gram portion of Mylar® film was cut into strips and reflux-extracted in 25 mL of 2-propanol for two hours. A 2-propanol blank extraction was also run. The extraction solvent for the Mylar® film appeared clear and colorless before extraction, and developed a white precipitate after extraction. The film sample was clear and colorless before and after extraction. The entire extraction medium was filtered through a 0.8-μm silver membrane to remove insoluble materials, and the filtrate was evaporated to dryness in a tared aluminum dish on a hot water bath. The 2-propanol blank was similarly evaporated to dryness, and the weight of residue subtracted from that of the Mylar® sample to determine the actual level of extractables. The calculated amount of precipitate, relative to the weight of the film, was 3400 ppm, and the soluble material obtained from the filtrate amounted to 6500 ppm. Thus the total level of extractables was 9900 ppm.

The 60-μm PVC film was extracted as above, and showed a clear and colorless solvent both before and after extraction. The film sample was hazy and colorless before extraction, and became very white and opaque after extraction. The amount of residue was 28800 ppm, considerably higher than that obtained from extraction of the Mylar® film.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A film composite structure comprising a first surface layer, said first surface layer comprising a biaxially oriented polyester film layer having an extractables level less than 15,000 ppm by weight, the composite structure further comprising:
(a) a first adhesive layer on said first surface layer;
(b) an aluminum layer on said adhesive layer; and
(c) an additional layer over said aluminum layer;
wherein the film composite structure is a cold-formable structure suitable for non-contaminating contact with a pharmaceutical product.

2. The composite structure of claim 1, wherein the additional layer comprises a polymer film.

3. The composite structure of claim 2, wherein the polymer film comprises a polyester film.

4. The composite structure of claim 2, wherein the polymer film comprises a polyamide film.

5. The composite structure of claim 2, wherein the polymer film comprises a polyvinyl chloride film.

6. The composite structure of claim 4, wherein the polyamide is biaxially oriented.

7. The composite structure of claim 1, wherein the first adhesive layer comprises a thermal bonding polyester resin.

8. The composite structure of claim 1, wherein the polyester film layer further comprises a slip additive.

9. The composite structure of claim 1, further comprising an adhesive between the aluminum layer and the additional layer.

10. The composite structure of claim 1, wherein the polyester film layer comprises polyethylene terephthalate comprising between 2.0 and 8.0 wt % of linear aliphatic a,ω-dicarboxylic acid repeating units selected from the group consisting of suberic acid, azelaic acid, and sebacic acid repeating units.

11. The composite structure of claim 1, wherein the polyester film layer comprises polyethylene terephthalate comprising between 1.0 and 4.0 wt % of diethylene glycol repeating units.

12. The composite structure of claim 10, wherein the a,ω-dicarboxylic acid component comprises azelaic acid repeating units and is present at a level between 4.0 and 5.0 wt %, the polyethylene terephthalate further comprising between 1.5 and 2.5 wt % of diethylene glycol repeating units.

13. The composite structure of claim 12, wherein the additional layer is substantially identical to the first surface layer.

14. The composite structure of claim 1, wherein the polyester film layer is essentially free of aromatic acid repeating units other than terephthalic acid.

15. The composite structure of claim 1, wherein the first surface layer has a glass transition temperature between 50 and 65° C. and a melting point between 228 and 240° C.

16. The composite structure of claim 1, wherein the biaxially oriented polyester film layer comprises polyethylene terephthalate comprises between 4.0 and 5.0 wt % of azelaic acid repeating units and between 1.5 and 2.5 wt % of diethylene glycol repeating units and further comprises a slip additive, wherein the additional layer comprises a polyester film, and wherein the cold-formable film composite structure further comprises an adhesive between the aluminum layer and the additional layer.

17. The composite structure of claim 1, wherein the cold-formable film composite structure further comprises a second surface layer having a low level of extractables, wherein the second surface layer is over said aluminum layer and over said additional layer, and is opposite the first surface layer.

18. The composite structure of claim 17, wherein the first and second surface layers are substantially identical and comprise between 4.0 and 5.0 wt % of azelaic acid repeating units and between 1.5 and 2.5 wt % of diethylene glycol repeating units, and wherein the additional layer comprises a polyamide film.

19. The composite structure of claim 17, wherein the polyamide film is biaxially oriented.

20. A pharmaceutical product container comprising a film composite structure comprising a first surface layer, said first surface layer comprising a biaxially oriented polyester film layer having an extractables level less than 15,000 ppm by weight, the composite structure further comprising:
(a) a first adhesive layer on said first surface layer;
(b) an aluminum layer on said adhesive layer; and
(c) an additional layer over said aluminum layer;
wherein the film composite structure is a cold-formable structure suitable for non-contaminating contact with a pharmaceutical product; and
wherein the film composite structure comprises a blister, surrounded by a flange, having a concave inner surface defining a cavity adapted to receive said pharmaceutical product, the first surface layer of the structure forming the concave inner surface.

21. The container of claim 20, wherein the polyester film layer comprises polyethylene terephthalate comprising between 4.0 and 5.0 wt % of azelaic acid repeating units and between 1.5 and 2.5 wt % of diethylene glycol repeating units.

22. The container of claim 20, wherein the cold-formable film composite structure further comprises a second surface layer having a low level of extractables, wherein the second surface layer is over said aluminum layer and over said additional layer, and is opposite the first surface layer.

23. The container of claim 22, wherein the first and second surface layers are substantially identical and comprise between 4.0 and 5.0 wt % of azelaic acid repeating units and between 1.5 and 2.5 wt % of diethylene glycol repeating units, and wherein the additional layer comprises a polyamide film.

24. The container of claim 20, further comprising a complementary lidding structure adhered to the first surface layer.

25. A method for forming a pharmaceutical product container comprising a film composite structure comprising a first surface layer, said first surface layer comprising a biaxially oriented polyester film layer having an extractables level less than 15,000 ppm by weight, the composite structure further comprising:
(a) a first adhesive layer on said first surface layer;
(b) an aluminum layer on said adhesive layer; and
(c) an additional layer over said aluminum layer;
wherein the film composite structure is a cold-formable structure suitable for non-contaminating contact with a pharmaceutical product; and
wherein the film composite structure comprises a blister, surrounded by a flange, having a concave inner surface defining a cavity adapted to receive said pharmaceutical product, the first surface layer of the structure forming the concave inner surface;
the method comprising:
(a) providing a complementary pair of die elements;
(b) positioning said composite structure between said elements; and
(c) pressing said die pair elements in complementary engagement without applying external heating to said composite structure to cold-form said composite structure, thereby forming said cavity.

26. The method of claim 25, further comprising, prior to said pressing, heating said composite structure to a temperature below a glass transition temperature of the first surface layer of said composite structure.

27. The method of claim 25, wherein during the pressing the die elements are at a temperature of at most 40° C.

28. The method of claim 25, wherein the polyester film layer comprises between 4.0 and 5.0 wt % of azelaic acid repeating units and between 1.5 and 2.5 wt % of diethylene glycol repeating units.
